(19) United States
(12) Patent Application Publication
(10) Pub. No.: US 2006/0223979 A1
(43) Pub. Date: Oct. 5, 2006

(54) Process for preparing polyether polyols

(76) Inventors: Thomas Ostrowski, Mannheim (DE); Raimund Ruppel, Dresden (DE); Eva Baum, Schwarzheide (DE)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/098,271

(22) Filed: Apr. 4, 2005

(51) Int. Cl. C08G 65/34; C08L 71/08

(52) U.S. Cl. 528/425

(57) ABSTRACT

A process for preparing polyether polyols comprises A) preparing a polyether polyol precursor, B) preparing a suspension of a DMC catalyst in a polyol, C) activating the DMC catalyst by bringing it into contact with an alkylene oxide, giving an activated DMC catalyst suspension, D) adding the activated DMC catalyst suspension from step C) to the polyether polyol precursor, E) reacting the polyether polyol precursor with alkylene oxide and, if appropriate, an H-functional starter substance in the presence of the activated DMC catalyst.

The invention relates to a process for preparing polyether polyols.

Polyols for producing flexible polyurethane foams are divided into polyols for slabstock flexible foams and polyols for molded flexible foams. Both types of polyol are at present prepared by the KOH method. Here, a starter, usually glycerol or trimethylolpropane (TMP), is placed in a reaction vessel, aqueous KOH solution is introduced and the mixture is dewatered. Alkylene oxides are subsequently fed in. In the case of polyols for slabstock flexible foams, a mixture of ethylene oxide (EO) and propylene oxide (PO) having an EO content of from 5 to 20% is generally introduced. Random copolymers having molar masses of from 2500 to 3500 g/mol are obtained. These products are used, for example, for producing foam mattresses. They display a low reactivity since they have predominantly secondary alcohol functions derived from propylene oxide.

On the other hand, polyols for molded flexible foams are generally block copolymers which have an inner block of propylene oxide or a random mixture of ethylene oxide and propylene oxide, with the inner block making up the major part of the molecular weight, and an end block of ethylene oxide. These reactive polyols have predominantly primary alcohol functions derived from ethylene oxide. At an EO content of 15%, a proportion of primary OH groups of from 70 to 90% is obtained. The molar masses of this type of polyol are in the range from 4000 to 6000 g/mol.

Double metal cyanide complexes are highly active catalysts for preparing polyether polyols by means of alkylene oxide polymerization. The catalysts make it possible to prepare polyether polyols having a narrow molecular weight distribution and very low degrees of unsaturation (very low monool contents) even at high molecular weights.

In the preparation of polyether polyols by the DMC method, it is usual to prepare a precursor using the feed stream process. Here, propylene oxide is fed in in parallel with glycerol or another starter substance. The simultaneous introduction of propylene oxide and starter substance prevents the starter substance from acting as a catalyst poison. Such a process is described, for example, in WO 97/29146.

It is also possible to react mixtures of ethylene oxide and propylene oxide over a DMC catalyst. Mixtures containing up to 20% of ethylene oxide can be processed without problems by this method.

The DMC catalyst is activated only on contact with the alkylene oxide. However, time elapses until the catalyst has been activated, as a result of which the batch times are increased. If an unsatisfactory catalyst activity is recognized only during the synthesis, this can lead to out-of-specification products. An unsatisfactory activity can lead to complete inactivity of the catalyst. However, problems can also occur in the reaction conditions. Thus, accumulation of alkylene oxides can occur, and this leads to pressure and temperature fluctuations. Products whose properties, for example the viscosity, are out of specification are frequently obtained in such a case. Since the prepolymers prepared in the feed stream process in turn serve as basis for the preparation of further prepolymers (generations procedure), the subsequent syntheses can also be adversely affected by an insufficiently active catalyst.

WO 98/52689 describes a process in which the starter polyol is mixed with the DMC catalyst and the mixture is stripped with an inert gas to increase the activity of the DMC catalyst before addition of alkylene oxide.

U.S. Pat. No. 6,486,361 describes a process in which, after the addition of catalyst, propylene oxide is added to the polyol in the reactor in such a way that the pressure in the reactor remains constant during the activation. Furthermore, a pressure of 1-6 bar is proposed for the activation. It is difficult to keep the pressure constant during the addition of propylene oxide during the activation of the DMC catalyst, since propylene oxide tends to react suddenly. The reaction of the propylene oxide also leads to liberation of heat and thus to a temperature increase which in turn causes the reactor pressure to rise. It is therefore difficult to carry out the process proposed in U.S. Pat. No. 6,486,361.

It is an object of the present invention to provide a process for preparing polyether polyols which comprises a simple-to-carry out and effective activation of the DMC catalyst and makes stable reaction conditions possible even with a small amount of catalyst.

This object is achieved by a process for preparing polyether polyols, which comprises
A) preparing a polyether polyol precursor,
B) preparing a suspension of a DMC catalyst in a polyol,
C) activating the DMC catalyst by bringing it into contact with an alkylene oxide, giving an activated DMC catalyst suspension,
D) adding the activated DMC catalyst suspension from step C) to the polyether polyol precursor,
E) reacting the polyether polyol precursor with alkylene oxide and, if appropriate, an H-functional starter substance in the presence of the activated DMC catalyst.

In step A), a polyether polyol precursor is prepared. The preparation can be carried out semicontinuously or fully continuously by means of DMC catalysis. In the semicontinuous mode of operation, previously prepared polyether polyol precursor is placed in a reactor. The polyether polyol precursor can have been prepared by conventional methods by means of KOH catalysis and subsequent removal of the catalyst. The polyether polyol precursor can come from a previous production cycle and have been prepared by means of DMC catalysis.

The polyether polyol precursor generally has an OH number of from 50 to 400 mg KOH/g and a mean molecular weight of from 200 to 4000 g/mol, preferably from 500 to 3000 g/mol.

In step B), the DMC catalyst is suspended in a polyol. As polyols in which the DMC catalyst is dispersed, preference is given to alkoxylated diols, trials and mixtures thereof having a mean molecular weight of from 200 to 5000 g/mol. Particular preference is given to using part of the polyether polyol precursor as prepared in step A) as suspension medium. The solids content of the catalyst suspension is generally from 2 to 10% by weight, preferably from 3 to 8% by weight.

Dispersion of the DMC catalyst in the polyol is carried out using customary comminution and mixing equipment, for example in a wet rotor mill or by means of an Ultra-Turrax installed in a pressure-rated reactor. Dispersion can also be effected by means of ultrasound.

In step C), the DMC catalyst is activated by bringing it into contact with an alkylene oxide. It is important that the activation of the DMC catalyst by means of the alkylene oxide is carried out before the DMC catalyst suspension is introduced into the polyether polyol precursor.

The activation of the DMC catalyst can be carried out in a tube reactor installed upstream of the alkoxylation reactor. Activation is preferably carried out simultaneously with the introduction of the catalyst suspension into the polyether polyol precursor.

The reaction of the alkylene oxide liberates heat, which results in a temperature increase. The catalyst activity can be monitored on-line via the change in temperature of the catalyst suspension during passage through the tube reactor and the amount of catalyst in the suspension can be altered if appropriate.

In a preferred variant of the process of the invention, the activation of the DMC catalyst by means of the alkylene oxide (step C)) is carried out during the preparation of the suspension (step B)).

The activation of the DMC catalyst can thus be carried out together with the dispersion of the catalyst in a wet rotor mill. For this purpose, the alkylene oxide can be added directly in front of the milling rotor of the wet rotor mill. Activation can also be carried out during dispersion of the catalyst by means of an Ultra-Turrax. For this purpose, the alkylene oxide is introduced into the reactor in which the Ultra-Turrax has been installed. The alkylene oxide can be introduced continuously during the entire duration of comminution/dispersion or can be introduced only from time to time.

In this variant of the process of the invention, too, on-line monitoring of the catalyst activity and control of the amount of catalyst can be effected via the age in temperature of the catalyst suspension.

The wet rotor mill is preferably set such that the gap width is from 0.005 to 0.05 mm. The milling times are, for example, in the range from 6 to 120 minutes. When an Ultra-Turrax is used, dispersion times of, for example, from 5 to 30 minutes result. In addition, dispersion of the DMC catalyst can also be effected by means of treatment with ultrasound and simultaneous introduction of PO or PO/starter. The abovementioned values apply to the preparation of a suspension having a solids content of about 5% by weight. The alkylene oxide or alkylene oxide/starter mixture can be added during the entire duration of dispersion or only from time to time. The designs of the mills, Ultra-Turrax instruments and the ultrasonic equipment are preferably selected so that particle sizes of from about 2 to 20 μm are produced at a dispersion time of from 5 minutes to 2 hours.

As additives to increase the activity further and/or to control the morphology, it is possible to add:
surfactants, for example those of the trade names Pluronic®, Plurafac®, Tegopren® and Zonyl®;
Brönsted acids, for example phosphoric acid, phosphorous acid, sulfuric acid, sulfurous acid, nitric acid, nitrous acid, boric acid, benzoic acid, acetic acid and formic acid;
Lewis acids, for example boron trifluoride etherate, tin(IV) chloride, titanium(IV) tetrabutoxide, zinc triflate, yttrium triflate, zinc chloride;
stabilizers for scavenging DMC catalyst poisons.

The additives mentioned are introduced during the dispersion process either directly into the mill or into the reactor in which the Ultra-Turrax has been installed. The additives can be added simultaneously with the alkylene oxide or before the alkylene oxide.

Suitable alkylene oxides are ethylene oxide, propylene oxide and butylene oxide. Activation of the DMC catalyst according to all the above-described variants of the process of the invention is preferably carried out using pure propylene oxide or an ethylene oxide/propylene oxide mixture. The DMC catalyst is generally activated using from 0.1 to 5 mol of alkylene oxide per mole of DMC catalyst. The temperature is from 50 to 150° C., preferably from 90 to 150° C., and the pressure is selected so that the alkylene oxide is liquid. For example, it can be 10 bar in the case of propylene oxide. In general, it is from 10 to 30 bar.

In one variant of the process of the invention, the activation of the DMC catalyst or the dispersion and activation is carried out in the presence of an H-functional starter substance. This can be added to the catalyst suspension either together with the alkylene oxide or separately therefrom. As H-functional starter substance in whose present the DMC catalyst is activated, it is possible to use the H-functional starter substance used in the alkoxylation of the polyether polyol precursor in step E) or a starter substance different from this. Preference is given to using the same H-functional starter substance. The amount of starter substance which is added to the alkylene oxide is up to 20% by weight, based on the amount of alkylene oxide which is added to activate the DMC catalyst.

Suitable H-functional starter substances include all compounds which have an active hydrogen. According to the invention, preference is given to OH-functional compounds as starter compounds.

Suitable starter compounds are, for example, the following compounds: water, organic dicarboxylic acids such as succinic acid, adipic acid, phthalic acid and terephthalic acid, and also monohydric or polyhydric alcohols such as monoethylene glycol, 1,2- and 1,3-propanediol, diethylene glycol, dipropylene glycol, 1,4-butanediol 1,6-hexanediol, glycerol, trimethylolpropane, pentaerythritol, sorbitol and sucrose. Preferred H-functional starter compounds are water, monoethylene glycol, diethylene glycol 1,2-propanediol, dipropylene glycol, glycerol, trimethylolpropane, triethanolamine, pentaerythritol sorbitol and/or sucrose, which can also be used as mixtures.

The mean functionality of the starter or the starter mixture is generally from 2 to 4, preferably from 2.2 to 3.0.

A preferred starter compound is glycerol. In one variant of the process of the invention, glycerol is used in admixture with a costarter selected from among sorbitol, dipropylene glycol, propanediol, ethylene glycol and diethylene glycol.

The activated DMC catalyst suspension from step C) is subsequently added to the polyether polyol precursor in a step D). This can occur in a continuous or semicontinuous process.

DMC compounds suitable as catalysts are described, for example, in WO 99/16775, EP 862 947 and DE 10117273.7. A particularly useful catalyst for the alkoxylation is a double metal cyanide compound of the general formula I:
M¹ₐ[M²(CN)_{b}(A)_{c}]_{d}·fM¹_{g}Xₙ·h(H₂O)·eL·kP (I)
where
M¹ is at least one metal ion selected from the group consisting of Zn²⁺, Fe²⁺, Fe³⁺, Co³⁺, Ni²⁺, Mn²⁺, Co²⁺, Sn²⁺, Pb²⁺, Mo⁴⁺, Mo⁶⁺, Al³⁺, V⁴⁺, V⁵⁺, Sr²⁺, W⁴⁺, W⁶⁺, Cr²⁺, Cr³⁺, Cd²⁺, Hg²⁺, Pd²⁺, Pt²⁺, V²⁺, Mg²⁺, Ca²⁺, Ba²⁺, Cu²⁺, La³⁺, Ce³⁺, Ce⁴⁺, Eu³⁺, Ti³⁺, Ti⁴⁺, Ag⁺, Rh²⁺, Rh³⁺, Ru²⁺, Ru³⁺,
M² is at least one metal ion selected from the group consisting of Fe²⁺, Fe³⁺, Co²⁺, Co³⁺, Mn²⁺, Mn³⁺, V⁴⁺, V⁵⁺, Cr³⁺, Cr³⁺, Rh³⁺, Ru²⁺, Ir³⁺,
A and X are each, independently of one another, an anion selected from the group consisting of halide, hydroxide, sulfate, carbonate, cyanide, thiocyanate, isocyanate, cyanate, carboxylate, oxalate, nitrate, nitrosyl, hydrogensulfate, phosphate, dihydrogen phosphate, hydrogen phosphate and hydrogencarbonate,
L is a water-miscible ligand selected from the group consisting of alcohols, aldehydes, ketones, ethers, polyethers, esters, polyesters, polycarbonate, ureas, amides, primary, secondary and tertiary amines, ligands having a pyridine nitrogen, nitriles, sulfides, phosphides, phosphites, phosphanes, phosphonates and phosphates,
k is a fraction or integer not less than zero, and
P is an organic additive,
a, b, c, d, g and n are selected so that the compound (I) is electrically neutral, with c being able to be 0,
e is the number of ligand molecules and is a fraction or integer not less than 0,
f, h and m are each, independently of one another, a fraction or integer not less than 0.

Organic additives P which may be mentioned are: polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid and maleic anhydride copolymers, hydroxyethylcellulose, polyacetates, ionic surface- and interface-active compounds, bile acids or their salts, esters or amides, carboxylic esters of polyhydric alcohols and glycosides.

These catalysts can be crystalline or amorphous. When k is equal to zero, crystalline double metal cyanide compounds are preferred. When k is great than zero, crystalline, partially crystalline and also substantially amorphous catalysts are preferred.

In the case of the modified catalysts, there are various preferred embodiments. One preferred embodiment is catalysts of the formula (I) in which k is greater than zero. The preferred catalyst then comprises at least one double metal cyanide compound, at least one organic ligand and at least one organic additive P.

In another preferred embodiment, k is zero, e is optionally also zero and X is exclusively a carboxylate, preferably formate, acetate or propionate. Such catalysts are described in WO 99/16775. In this embodiment, crystalline double metal cyanide catalysts are preferred. Preference is also given to double metal cyanide catalysts as described in WO 00/74845, which are crystalline and platelet-like.

The modified catalysts are prepared by combining a metal salt solution with a cyanometalate solution which can optionally contain both an organic ligand L and an organic additive P. The organic ligand and optionally the organic additive are subsequently added. In a preferred embodiment of the preparation of the catalyst, an inactive double metal cyanide phase is prepared first and this is subsequently converted by recrystallization into an active double metal cyanide phase, as described in PCT/EP01/01893.

In another preferred embodiment of the catalysts, f, e and k are not equal to zero. The catalysts are then double metal cyanide catalysts which contain a water-miscible organic ligand (generally in amounts of from 0.5 to 30% by weight) and an organic additive (generally in amounts of from 5 to 80% by weight), as described in WO 98/06312. The catalysts can be prepared either with intensive stirring (24 000 rpm using a Turrax) or with stirring, as described in U.S. Pat. No. 5,158,922.

Particularly useful catalysts for the alkoxylation are double metal cycanide compounds containing zinc, cobalt or iron or two of these. An example of a particularly suitable compound is Berlin blue.

Preference is given to using crystalline DMC compounds. In a preferred embodiment, a crystalline DMC compound of the Zn—Co type containing zinc acetate as further metal salt component is used as catalyst. Such compounds crystallize in a monoclinic structure and are platelet-like. Such compounds are described, for example, in WO 00/74845 or PCT/EP01/01893.

DMC compounds suitable as catalysts can in principle be prepared by all methods known to those skilled in the art. For example, the DMC compounds can be prepared by direct precipitation, the “incipient wetness” method, by preparation of a precursor phase and subsequent recrystallization.

The DMC compounds can be used as a powder, paste or suspension or can be shaped to form a shaped body, introduced into shaped bodies, foam or the like or applied to shaped bodies, foams or the like.

The catalyst concentration used for the alkoxylation based on the final amounts, is typically less than 2000 ppm, preferably less than 1000 ppm, in particular less than 500 ppm, particularly preferably less than 100 ppm, for example less than 50 ppm.

In a step E), the polyether polyol precursor is reacted with alkylene oxide and, if appropriate, an H-functional starter substance in the presence of the activated DMC catalyst.

The alkoxylation of the polyether polyol precursor can be carried out continuously or semicontinuously.

Suitable continuously operating reactors are, for example, a continuous stirred tank reactor (CSTR), a continuously operated jet loop reactor with internal heat exchanger tubes and a continuously operated, completely filled circulation reactor. Also suitable are tube reactors with or without internals or packing and one or more points for introducing alkylene oxide, which can be operated individually or in the form of shell-and-tube reactors. An example of a suitable batch reactor is a stirred tank reactor.

In the alkoxylation step E), the polyether polyol precursor is reacted with alkylene oxide, preferably with propylene oxide or an ethylene oxide/propylene oxide mixture, in the presence of the DMC catalyst. H-functional starter substance is preferably added during the addition of alkylene oxide, at least from time to time. The alkoxylation step E) can be carried out in a plurality of stages. For example, the polyether polyol precursor can be alkoxylated by means of a first alkylene oxide or alkylene oxide mixture to form a polyether polyol intermediate. The polyester polyol intermediate can subsequently be reacted in one or more further stages with further alkylene oxides or alkylene oxide mixtures to give the final polyether polyol. A degassing step can be carried out between the individual steps. The polyether polyol intermediate can also be mixed with an alkali metal hydroxide and subsequently reacted with ethylene oxide to form the end product. The catalyst can subsequently be separated off from the end product obtained. Suitable methods for separating it off are known from the prior art.

The invention is illustrated by the following examples.

### EXAMPLES

### Example 1

A reactor which has a capacity of 25 l and is equipped with internal cooling coils for removing heat is used. Metering facilities for alkylene oxide, starter substance and DMC catalyst suspension are present.

The DMC catalyst prepared as described in EP-A 0 862 947 is dispersed as a moist filter cake in a propoxylate of glycerol/diethylene glycol in a molar ratio of 3:1 having an OH number of 152 mg KOH/g and prepared by means of KOH catalysis. The catalyst cake is subsequently dispersed using an Ultra-Turrax and the DMC catalyst suspension is dried at 130° C. under reduced pressure. The catalyst suspension used here has a DMC concentration of 5.11% by weight.

2.5 kg of the glycerol/diethylene glycol propoxylate having an OH number of 152 mg KOH/g and prepared by means of KOH catalysis are placed in the reactor and heated to 120° C. 0.062 kg of the DMC catalyst suspension is subsequently metered into the reactor at a rate of 5 ml/min by means of an HPLC pump. After the end of the catalyst addition, 1.66 kg of glycerol/diethylene glycol mixture in a molar ratio of 3:1 are metered in at a rate of 0.32 kg/h simultaneously with 15.8 kg of PO at a rate of 3.0 kg/h.

After the starter and propylene oxide addition is complete, the intermediate product is degassed. The DMC concentration in the product is 158 ppm and the OH number is 152 mg KOH/g.

The intermediate is converted into the end product in the same reactor. For this purpose, a mixture of 11.68 kg of PO/EO in a mass ratio of 93.4:16.6 is firstly metered into 6.32 kg of the intermediate at a temperature of 120° C. 2.0 kg of PO are subsequently metered in. The metering rate is in each case 8 kg/h.

This gives a product having a viscosity of 548 mPas at an OH number of 48.2 mg KOH/g. The product can be processed to form foam without any problems.

### Example 2

Analogous to Example 1, but only 0.0496 kg of DMC suspension is metered into the initially charged glycerol/diethylene glycol propoxylate.

An intermediate having a KOH number of 151 mg KOH/g is obtained. During the preparation of the intermediate, the metering of glycerol/DEG had to be stopped a number of times because accumulation of PO occurs. This increases the metering time by about 50%. The end product has a viscosity of 684 mPas and an OH number of 47.7 mg KOH/g and contains 41 ppm of the DMC catalyst. The slabstock flexible foam produced therefrom has cracks.

### Example 3

Using a method analogous to Example 2, 0.0496 kg of catalyst suspension is metered into the initial charge (2.50 kg) over a period of about 10 minutes at a rate of 5 ml/min by means of the HPLC pump. However, PO is introduced at a rate of 0.5 ml/min into the catalyst suspension over the entire metering time via a T-piece in the metering line by means of an HPLC pump. After addition of the catalyst, an intermediate having an OH number of 152 mg KOH/g is prepared as in Examples 1 and 2 and this is alkoxylated further to form the end product. The end product has a viscosity of 563 mPas and an OH number of 48.4 mg KOH/g. The catalyst concentration in the end product is 39 ppm. Foaming to produce slabstock flexible foam led to foams without cracks.

This example shows that the preactivation of the DMC catalyst by means of PO in a tube reactor installed upstream of the alkoxylation reactor gives a catalyst having a higher activity. As a result, stable reaction conditions can be maintained even at a significantly reduced catalyst concentration and an in-specification end product is obtained.

### Example 4

Analogous to Example 3, but 2% by weight of glycerol are mixed into the PO before it is introduced into the catalyst suspension. This PO/glycerol mixture is subsequently introduced at a rate of 0.5 ml/min into the metering line for the catalyst suspension. An intermediate is firstly prepared as described in Examples 1-3 and is converted into the end product in the second step. The end product has a viscosity of 543 mPas and an OH number of 48.1 mg KOH/g. The catalyst concentration in the end product is 38 ppm. Foaming to produce slabstock flexible foam leads to foams without cracks.

### Example 5

The catalyst obtained as a moist filter cake as described in EP-A 0 862 947 is dried at 100° C. and 13 mbara 10 kg of intermediate 1 (propoxylate of glycerol/diethylene glycol in a molar ratio of 3:1 having an OH number of 178 mg KOH/g and prepared by means of KOH catalysis and having an alkalinity of <1 ppm) are placed in a reactor and 500 g of catalyst are placed in the reservoir of the wet rotor mill (FrymaKoruma MZ80A). Milling is carried out for 40 minutes at T=25° C. The DMC catalyst suspension obtained has a solids content of 5.11% by weight.

2.50 kg of intermediate 2 (propoxylate of glycerol/diethylene glycol in a molar ratio of 3:1 having an OH number of 152 mg KOH/g and prepared by means of KOH catalysis and having an alkalinity of <1 ppm) are placed in a reactor and 0.062 g of the DMC catalyst suspension (5.11% by weight, corresponding to 50 ppm of DMC in the end product) are metered in at a rate of 5 ml/min by means of an HPLC pump. Subsequently, at a reaction temperature of 120° C., 1.66 kg of a glycerol/diethylene glycol mixture (molar ratio 3:1) are metered in at a rate of 320 g/h simultaneously with 15.8 kg of PO at a rate of 3.0 kg/h.

An intermediate having an OH number of 152 mg KOH/g is obtained. The catalyst concentration is 158 ppm. During the preparation of the intermediate, accumulation of propylene oxide with sudden reaction of the propylene oxide occurs frequently, resulting in temperatures of up to 154° C.

The product is converted into the end product in the same reactor. Here, a mixture of 11.68 kg of PO/EO in a molar ratio of 93.4:16.6 is firstly metered into 6.32 kg of the intermediate at 120° C. 2.0 kg of PO are subsequently metered in. The metering rate is in each case 8 kg/h.

The end product has a viscosity of 684 mPas and an OH number of 48.5 mg KOH/g. When the product is foamed to form slabstock flexible foam, cracks occur in the foam.

### Example 6

The DMC catalyst prepared as described in EP-A 862 947, which is obtained as a moist filter cake, is dried at 100° C. and 13 mbara. 10 kg of precursor having an OH number of 178 mg KOH/g are placed in a reactor and 500 g of the catalyst are placed in the reservoir of a commercial wet rotor mil. The catalyst is firstly milled for 5 minutes at 80° C. 56 g of PO are subsequently fed in directly before the milling rotor over a period of 35 minutes. The suspension subsequently has a DMC concentration of 5.02% by weight.

The subsequent procedure is exactly as in Example 5. During the synthesis, accumulation of propylene oxide and sudden reaction do not occur. An intermediate having an OH number of 153 mg KOH/g is obtained. The catalyst content of the intermediate is 156 ppm.

The intermediate is subsequently reacted with further alkylene oxide as described in Example 5. An end product having a viscosity of 587 mPas and an OH number of 48.2 mg KOH/g is obtained. Foaming of the product leads to a slabstock flexible foam which has no cracks.

### Example 7

The DMC catalyst prepared as described in EP-A 0 862 947, which is obtained as a moist filter cake, is dried at 100° C. and 13 mbara. 10 kg of intermediate having an OH number of 178 mg KOH/g are placed in a reactor and 500 g of the catalyst are placed in the reservoir of the wet rotor mill. The catalyst is firstly milled for 5 minutes at 80° C. 56 kg of PO containing 2.8 g of dissolved glycerol/diethylene glycol mixture in a molar ratio of 3:1 are subsequently fed in directly before the milling rotor over a period of 35 minutes. The catalyst suspension has a DMC concentration of 5.05% by weight.

The subsequent procedure is exactly as in Example 5. During the preparation of the intermediate, accumulation of propylene oxide and sudden reaction do not occur. An intermediate having an OH number of 151 mg KOH/g and a catalyst concentration 152 ppm is obtained.

In the second step, the intermediate as described in Example 1 is reacted with further alkylene oxides. An end product having a viscosity of 546 mPas and an OH number of 47.9 mg KOH/g is obtained. Foaming of the product leads to a slabstock flexible foam which has no cracks.

1. A process for preparing polyether polyols, which comprises
A) preparing a polyether polyol precursor,
B) preparing a suspension of a DMC catalyst in a polyol,
C) activating the DMC catalyst by bringing it into contact with an alkylene oxide, giving an activated DMC catalyst suspension,
D) adding the activated DMC catalyst suspension from step C) to the polyether polyol precursor,
E) reacting the polyether polyol precursor with alkylene oxide and, if appropriate, an H-functional starter substance in the presence of the activated DMC catalyst.

2. The process according to claim 1, wherein the preparation of the DMC catalyst suspension is carried out using a wet rotor mill.

3. The process according to claim 1, wherein the preparation of the DMC catalyst suspension is carried out using an Ultra-Turrax.

4. The process according to claim 1, wherein the activation of the DMC catalyst by means of the alkylene oxide in step C) is carried out in a tube reactor.

5. The process according to claim 1, wherein the activation of the DMC catalyst by means of the alkylene oxide (step C)) is carried out during the preparation of the suspension (step B)).

6. The process according to claim 5, wherein the steps B) and C) are carried out in a wet rotor mil.

7. The process according to claim 1, wherein the DMC catalyst is activated using from 0.1 to 5 mol of alkylene oxide per mole of DMC catalyst in step C).

8. The process according to claim 1, wherein the DMC catalyst is activated by means of propylene oxide in step C).

9. The process according to claim 1, wherein the DMC catalyst is activated by means of an ethylene oxide/propylene oxide mixture in step C).

10. The process according to claim 1, wherein the activation of the DMC catalyst in step C) is carried out in the presence of an H-functional starter substance.
